(19) United States
(12) Patent Application Publication
(10) Pub. No.: US 2011/0083479 A1
(43) Pub. Date: Apr. 14, 2011

(54) Cylinder lockset with a focusing apparatus

(76) Inventors: Chun-Sheng Hsu, Taipei City (TW); Kuang-Jui Chang, Taipei City (TW); Yuan-Yu Hsu, Taipei City (TW); Huan-Ching Hsu, Taipei City (TW)

(21) Appl. No.: 12/576,337

(22) Filed: Oct. 9, 2009

(51) Int. Cl. E05B 63/00

(52) U.S. Cl. 70/57.1; 70/419

(57) ABSTRACT

The primary object of the present invention is related to a cylinder lockset with a focusing apparatus which is comprised of a rotary disc, an upper pins seat, a bottom pins seat and a lock pad. The rotary disc of the invention is transfixed with a certain number focusing holes. The upper pins seat is transfixed with a certain number real and dummy corresponding holes & pins. The real corresponding holes of the upper pins seat are corresponded to the focusing holes of rotary disc and be provided with the corresponding pins. The dummy corresponding holes of the upper pins seat have dummy pins, springs and spring pads, which can be or can not be corresponded to the focusing holes of rotary disc. The bottom pins seat is transfixed with a certain number corresponding holes which be provided with corresponding pins, springs that can be corresponded to the real corresponding holes of the upper pins seat and the focusing holes of rotary disc. Unlocking operation of the lockset only can be activated to release the locking status successfully when the rotary disc of lockset can be rotated easily and all the specified focusing holes can be accurately corresponded to the real pin holes of upper pins seat by right key. The new invention of focusing apparatus will increase more difficulty of mathematical puzzle to open the lockset to any illegal intruder, which is able to increase locking security and advanced burglarproof capability.

### BACKGROUND OF THE INVENTION

a) Field of the Invention

The invention is related to a cylinder lockset with an irregular porous latching apparatus, which on the strength of two rotary focusing discs to increase more difficulty to open the lockset illegally and thus offer more locking security from burglar.

b) Description of the Prior Latching Technique

most of the existing lockset is designed with porous latching apparatus, the porosity all are disposed in regular matrix, or in orbit of cylinder disc. The porous latching apparatus in regular disposition is very easy to breakthrough by simple tools on purpose.

Refer to the case of Taiwan Patent no., 200615437 ┌Cylinder Lock with identified apparatus┘ is applied for a cylinder lock with an upper pins seat and a bottom pins seat inside. The upper and bottom pins seat are designed with a certain number pins & springs at radius of orbit, a control post to stem by spring and latching element are designed at radial and axial. One end of latching element is located at the corresponding hole of housing, the other end is located the concaved slot of control post. When using a right key, pins of the upper pins seat will be pushed and retract back to the rotary surface and the latching element will be pushed back to the receiving slot of the control post at same time, then can rotate the key to open the lockset. On the contrary, using wrong key can not rotate the latching apparatus to open it.

The upper & bottom pin disposition of the aforesaid cylinder lock are in regular axial orbit and the spring driving control post is located at center. Invader can use a plastic tube to insert & reach the upper and bottom pin correspondingly, to conjoin an object at the other end, and conjoin a screw at the center of object, which correspond to the control post of lock. On the strength of gauging the highness of control post by tube repeatedly, invader can adjust the screw on the center of object according to the indent of tube to lead the latch to retract back to the receiving slot of control post, then open it easily. Obviously, those kinds of cylinder lockset still have lots of shortcoming to improve.

### SUMMARY OF THE INVENTION

In view to advance the existing latching technique and to enforce the burglarproof function of lockset, the innovation of a cylinder lock with focusing apparatus is designed with porous rotary disc. The disc is corresponded to an upper pins seat, which is designed with a certain number real and dummy pins. On the strength of interact between the rotary disc and the upper pins seat, due to its real and dummy pins in different length as well as the irregular disposition of the porosity to increase mathematical variation of the focusing and bias holes and thus to enhance locking capability of lockset accordingly.

The invention is integrated by a hollow cylinder housing. Inside of chamber is comprised by a rotary disc, an upper pins seat, a bottom pins seat and a lock pad. The rotary disc is transfixed with a certain number focusing and bias holes, which can be rotated to the upper pins seat correspondingly.

The upper pins seat is designed in collar shape with an axle and several transfixed holes. The transfixed holes are designed for real and dummy pins. The real holes can be corresponded to the focusing holes of rotary disc, and the dummy holes can be or can not be corresponded to the focusing holes of rotary disc.

The bottom pins seat is designed in cylinder shape with an axial hole to receive the axle of upper pins seat. The bottom pins seat is transfixed with several bottom pin holes in corresponding to the real upper pin holes, all with pin & spring.

The lock pad is a disc and is perforated by the axle of upper pins seat, and conjoin with housing by the male thread of flange.

The aforesaid cylinder lockset with focusing apparatus, the focusing and bias holes of the rotary disc are disposed in varied radial area, and the focusing hole to bias hole distance can be in same or different. The real and dummy pin holes of upper pins seat are disposed in varied radial area, and the disposed radius is same as the focusing holes and bias holes. The hole to hole distance of real and dummy holes can be in same or different.

The aforesaid cylinder lockset with focusing apparatus, some of real upper pin holes of the upper pins seat are designed with real pins in different designed length. Some of dummy pin holes of the upper pins seat are designed with dummy pins, springs, spring pads and the dummy pins are in different length.

The aforesaid cylinder lockset with focusing apparatus, the bottom pin holes are designed with pins in different designed length.

The aforesaid cylinder lockset with focusing apparatus, a concave on the end of housing where is closed to the rotary disc is designed with a slot, which is extended to the inside of chamber to be a curved slot.

The aforesaid cylinder lockset with focusing apparatus, the rotary disc is protruded with a guiding post.

The aforesaid cylinder lockset with focusing apparatus, the key is designed with a certain number real pins, which are corresponded to the focusing holes of rotary disc. The length of real pins shall be longer than the thickness of rotary disc, which are corresponded to the focusing holes and real upper pin holes and reaching the real upper pins to the rotary surface between the upper and bottom pins seat.

The aforesaid cylinder lockset with focusing apparatus, the real pins of key are designed in different length.

The aforesaid cylinder lockset with focusing apparatus, the key is designed with a certain number dummy pins, which are corresponded to the bias holes of rotary disc, and the length of dummy pins are shorter than the thickness of rotary disc.

The aforesaid cylinder lockset with focusing apparatus, the dummy pins of key are designed in different length.

The aforesaid cylinder lockset with focusing apparatus, the hatch of key is designed with a receiving hole, which is corresponded and to receive the guiding post of rotary disc.

The aforesaid cylinder lockset with focusing apparatus, the flange of key is designed with a locking block, which is corresponded to the slot of housing and latching into the curved slot of chamber.

The rotary disc and upper pins seat of the innovation are designed with focusing and bias porosity in irregular disposition, together with different length of real and dummy pins to interact into complicated variation and become more difficulty to open it illegally.

Only to use right key to correspond to the focusing holes of rotary disc and the real corresponding holes of upper pins seat, as well as to match all the length of real pins and reaching to the rotary surface between upper and bottom pins seat, then to release locking status successfully.

To enable further understanding of the aforesaid objectives and the technique of the invention herein, the brief description of the below drawings are followed by more detailed description of the preferred embodiments.

### BRIEF DESCRIPTION OF THE DRAWINGS

FIG. 1 Showing the schematic view of the key appearance of the present invention.

FIG. 2 Showing the exploded view of the present invention.

FIG. 3 Showing the another direction exploded view of the present invention.

FIG. 4 Showing the cross-section view of locking status of the present invention.

FIG. 5 Showing the cross-section view of unlocking status of the present invention.

FIG. 6 Showing the section view of the present invention wherein the focusing hole of rotary disc are corresponded to the real holes of upper pins seat, as well as in the bias of others.

FIG. 7 Showing the section view of the present invention wherein the bias holes of the rotary disc are corresponded to the dummy holes of upper pins seat in bias.

FIG. 8 Showing another section view of the present invention wherein the others bias holes of rotary disc are corresponded to the dummy holes of upper pins seat.

### DETAILED DESCRIPTION OF THE PREFERRED EMBODIMENTS

Hereunder describe more detailed embodiment of invention by the attached drawings for reference. All similar or same referred terminology are described the similar or same elements, or are the elements in similar or same function from the beginning to the end. The attachments are the samples to explain the invention in details, it can not be extended to be the limitation of patent to the innovation.

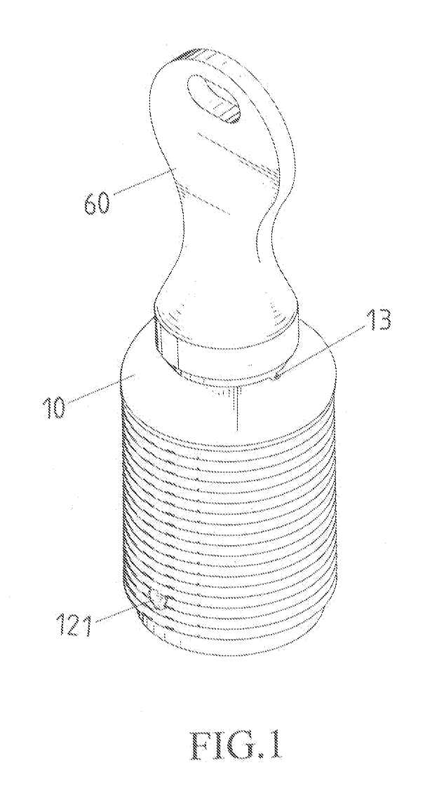

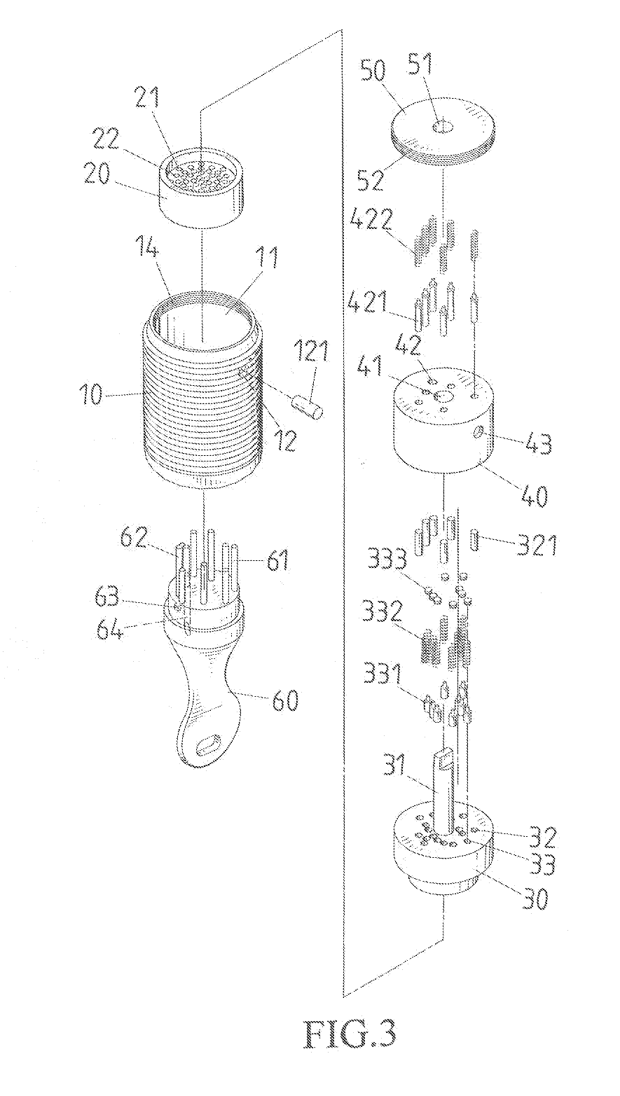

Referring to FIGS. 1 to 3, the invention is comprised a housing 10, a rotary disc 20, an upper pins seat 30, a bottom pins seat 40 and a lock pad 50.

The housing 10 is a hollow cylinder, the inside is a chamber 11 in different aperture to receive the rotary disc, the upper pins seat, the bottom pins seat and lock pad. The annular wall of housing 10 is drilled a fixed hole 12, and is transfixed by a fixed post 121. The end surface of housing 10 is concaved with a slot 13 which is extended into the inner wall of housing 10 to be a curved slot 131; whereas, the inner wall at the other end of housing 10 is formed with a female thread 14.

The rotary disc 20 is a round disc with porous focusing holes 21 and bias holes 22, those are disposed axially in the same or different radius from center, and the distance between focusing holes and bias holes can be in same or different. In addition, the rotary disc 20 is protruded with an axial guiding post 23 at annulet.

The upper pins seat 30 is a porous collar with an axle 31. Its perforated holes are designed with a certain number of real and dummy upper pins holes 32, 33 which are disposed axially in same or different radius from the center and the distance of each real or dummy pin hole 32, 33 can be in same or different. Each real upper pin hole 32 is corresponded to the focusing hole 21 and is provided with a real corresponding pin 321. Each dummy upper pin hole 33 is corresponded or is not corresponded to the focusing hole 21 and bias hole 22. Some of the dummy upper pin holes 33 are with a dummy pin 331, a spring 332 and a spring pad 333 in sequence, and each real or dummy upper pin 321, 331 is designed respectively in different length.

The bottom pins seat 40 is a cylinder and the center is transfixed with an axial hole 41. The bottom pins seat 40 is transfixed with porous bottom pin holes 42 which are disposed axially, the bottom pin holes 42 are corresponded to the real upper pin holes 32 and each bottom pin hole 42 has a bottom corresponding pin 421 and a spring 422. The bottom pins 421 can be designed in different length and the bottom pins seat 40 is with a fixed hole 43 which is corresponded to the fixed hole 12 of the housing 10.

The lock pad 50 is a round disc with a perforated axial hole 51. In addition, the rim of the lock pad 50 is designed with male thread 52 to conjoin with the female thread 14 of housing 10.

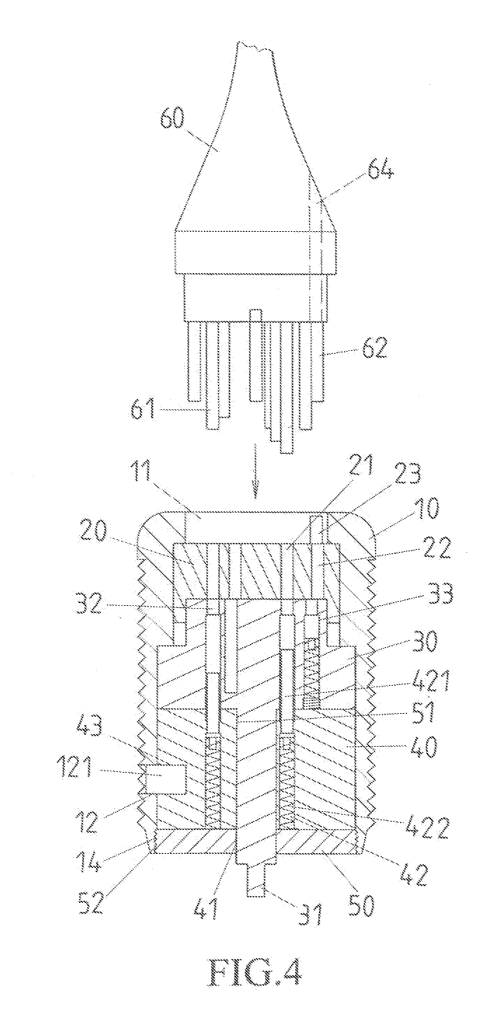

Referring to FIG. 4, the chamber 11 of the housing 10 is received the rotary disc 20, the upper and bottom pins seat 30, 40 and the lock pad 50 in sequence. The fixed post 121 transfixes the fixed hole 12 of the housing 10 and is fixed into the fixed hole 43 of the bottom pins seat 40; whereas, the rotary disc 20 can be rotated relatively to the upper pins seat 30, the lock pad 50 is conjoined into the female thread 14 of the housing 10 by the male thread 52 and the axle 31 of the upper pins seat 30 transfixes out of the axial hole 41 of the bottom pins seat 40 and the perforated hole 51 of the lock pad 50.

Referring to FIGS. 1 to 3, the key 60 of the invention is designed with number of real and dummy thrust pins 61, 62 which are disposed correspondingly to the focusing holes 21. The real and dummy pins 61, 62 are designed in different length, the length of the real pin 61 is longer than the thickness of the rotary disc 20 which can be correspondingly inserted into the focusing hole 21, and reach to the real upper pin 321. The length of the dummy pin 62 is shorter than the thickness of the rotary disc 20 and which can be correspondingly inserted into the bias hole 22; whereas, the flange of the key 60 is designed with a locking block 63 which is corresponded to the slot 13 of the housing 10. In addition, the hatch of the key 60 is designed with a receiving hole 64 which receive correspondingly to the guiding post 23 of the rotary disc 20.

Referring to FIG. 4, the spring 422 of the bottom pin hole 42 provides the retractable force, allowing the bottom pin 421 to be located in the real upper pin hole 32 and the bottom pin hole 42 simultaneously. As the bottom pin 421 is located at the rotary surface between the upper pins seat 30 and the bottom pins seat 40, the upper pins seat 30 can not be rotated relatively to the bottom pins seat 40 and this is a locking status of the lockset.

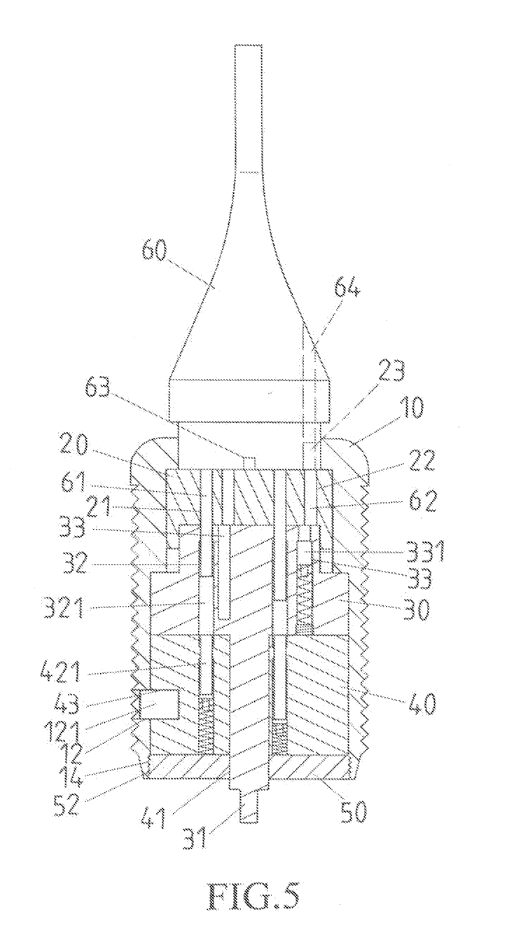

Referring to FIG. 5, when the real and dummy pins 61, 62 of the key 60 correspond to and are inserted into the focusing hole 21, the real pins 61 will be thrust into the real upper pin holes 32 to push the real upper pins 321 and the real upper pins 321 will push the bottom pins 421 to move and retract from the upper pin holes 31, allowing the contact surface of the real upper pins 321 with the bottom pins 421 to be located at the rotary surface between the upper pins seat 30 and the bottom pins seat 40, or allowing the contact surface of the real pins 61 with the real upper pins 321 to be located at the rotary surface between the bottom pins seat 40 and the upper pins seat 30. At the moment, the upper pins seat 30 can be rotated relatively to the bottom pins seat 40. The unlocking function can be thus activated by rotating the key 60 accordingly.

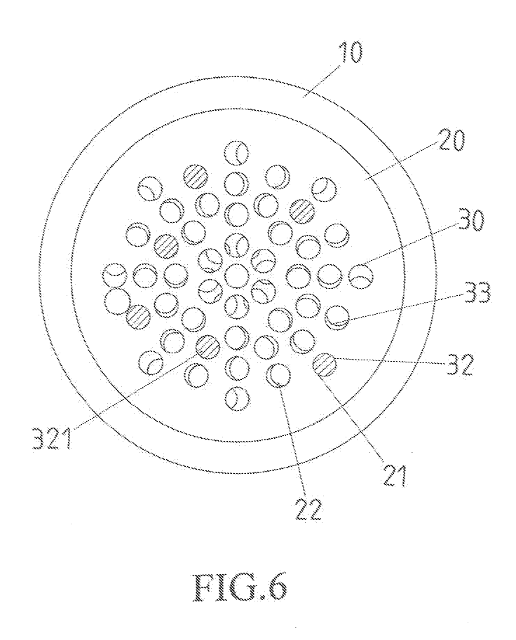

Referring to FIGS. 5 and 6, when unlocking, the rotary disc 20 must be rotated relatively to the upper pins seat 30 that specified focusing holes 21 focus accurately to the real upper pins holes 32. While other focusing holes 21 can focus or be off-centered to the dummy upper pin holes 33, and then the key 60 is inserted, allowing the real pins 61 to push the real upper pins 321, thereby opening the lockset. Since the rotary disc 20 and the upper pins seat 30 of the invention are transfixed respectively with the plural focusing holes 21 as well as real and dummy upper pin holes 32, 33, to any invader will be very difficult to tell the difference between the real and dummy upper pin holes 32, 33 and only may keep rotating the rotary disc 20 in vain.

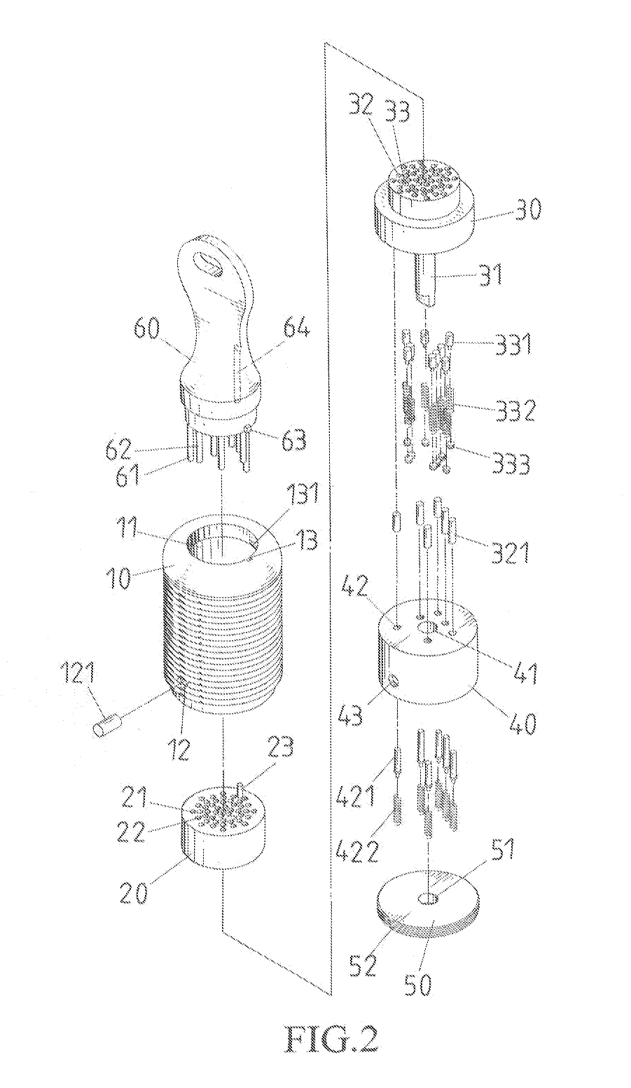

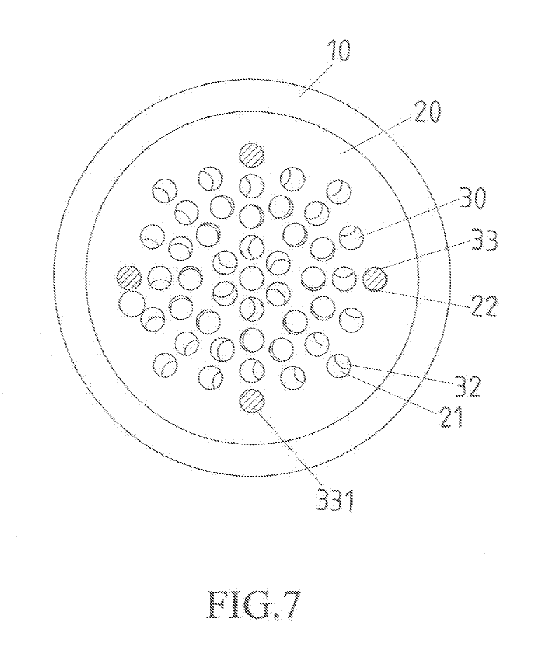

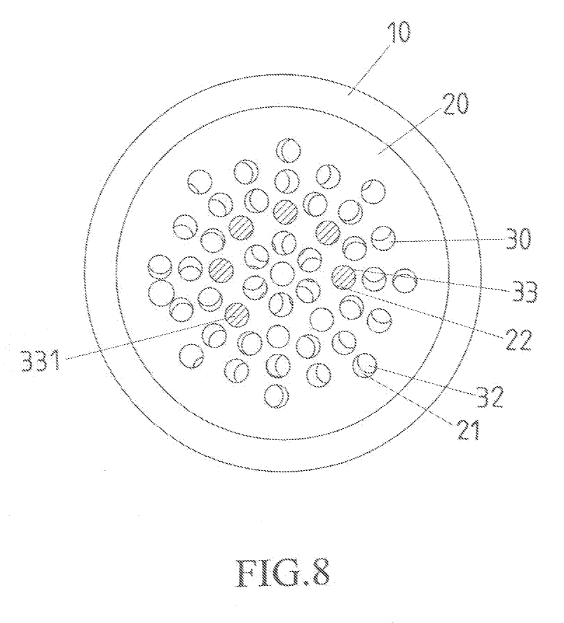

Referring to FIGS. 2, 7 and 8, when the rotary disc 20 is rotated incorrectly, part of the focusing holes 21 focus to the specified dummy upper pin holes 33, part of the focusing holes 21 will be off-centered to the real upper pin holes 32 and then it is unable to open the lockset. Furthermore, as part of the dummy upper pin holes 33 are designed with the dummy upper pins 331, when invader attempt to use a tool to open the lockset illegally, if a tool is intruded into the dummy upper pin holes 33 and push the dummy upper pins 331, invader will be misguided that these are the real upper pins 321 due to the retracted force of the spring 332 under the dummy upper pins 331. Therefore, invader will confuse which are the real focusing hole 21 to open the lockset. In addition, the irregular focusing holes 21 design also increases difficulty when invader attempts to open the lockset illegally. Consequently, the lockset can only be easily opened by using the right key 60, thereby providing more sophisticated locking capability.

Referring to FIGS. 2 and 5, the guiding post 22 is also provided with a fool-proof function. No matter where the rotary disc 20 is rotated to, the guiding post 22 can correspond to and be latched into the receiving hole 64 of the key 60, the locking block 63 of the key 60 can correspond to and be snapped into the slot 13 of the housing 10 and the key 60 is rotated to open the lockset; at this time, the locking block 63 will latch into the curved slot 131. Therefore, the lockset can be opened easily by using the right key 60.

Referring to FIGS. 2 and 4, when the key 60 is removed, the key 60 must be rotated reversely, allowing the locking block 63 to move reversely from the curved slot 131 till corresponding to the slot 13 of the housing 10 that the key 60 can be taken out. At the moment, the real upper pins 321 will be released by the force of the real thrust pins 61 and retract back to the real upper pin holes 32; whereas, the bottom pins 421 are retracted to the rotary surface between the upper pins seat 30 and the bottom pins seat 40, then restore in the locking status.

Furthermore, according to a theory of physical experiments, when the ratio of thickness of rotary disc 20 to the aperture of focusing hole 21 is larger than a certain proportion, it is difficult to distinguish the real and dummy upper pin holes 32, 33 on the upper pins seat 30 through the focusing holes 21 to carry on the focusing operation, even under a sufficient lighting source. As a result, all kinds of focusing possibilities for the focusing holes 21 of rotary disc 20 and the real and dummy upper pin holes 32, 33 of upper pins seat 30 are only theoretical possibilities. Practically, the locations and quantities of the real upper pins 321 are invisible with naked eyes and therefore, if do not using the right key 60 to unlock, any invader only can indiscernibly rotate the rotary disc 20 and is hard to open the lockset. Consequently, the invention is provided with an outstanding locking effect.

It is of course to be understood that the embodiments described herein is merely illustrative of the principles of the invention and that a wide variety of modifications thereto may be effected by persons skilled in the technique without departing from the spirit and scope of the invention as set forth in the following claims.

What are we claimed:

1. A cylinder lockset with a focusing apparatus, comprise a housing which is a hollow cylinder and the inner chamber is received a rotary disc, an upper pins seat, a bottom pins seat and a lock pad; Wherein the rotary disc is a round disc with plural focusing and bias holes, which is rotated relatively to the upper pins seat; The upper pins seat is in a collar shape and the center is protruded axially with an axle; Te upper pins seat is transfixed with plural real and dummy upper pin holes, the real upper pin holes are corresponded to the focusing holes of the rotary disc and each real upper pin hole being provided with a real upper pin, whereas the dummy upper pin holes correspond or do not correspond to the focusing holes; The bottom pins seat is a cylinder and the center is perforated by the axle of upper pins seat and is transfixed with plural bottom pin holes which correspond to the real upper pin holes, each bottom pin hole being provided with a bottom pin and a spring. The lock pad is a round disc and the center is perforated with an axial hole which is transfixed by the axle of upper pins seat; The lock pad is conjoined at the end of the lock housing by male thread.

2. The cylinder lockset with a focusing apparatus according to claim 1, wherein the focusing holes and the bias holes are disposed in the same or different radial area from the center to outer of rotary disc and the distance of each focusing hole to bias hole can be in the same or different; The real and dummy upper pin holes are disposed in the same or different radius from the center to outer of upper pins seat, and the disposition shall correspond to the same as the disposition of focusing holes, and the distance of hole to hole can be in the same or different.

3. The cylinder lockset with a focusing apparatus according to claim 1, wherein each real and dummy upper pin are designed in different length and each bottom pin is designed in different length.

4. The cylinder lockset with a focusing apparatus according to claim 1 to claim 3, wherein a concave on the end of housing where is closed to the rotary disc is designed with a slot, which is extended to the inside of chamber to be a curved slot.

5. The cylinder lockset with a focusing apparatus according to claim 1 to claim 3, wherein the rotary disc is protruded with an axial guiding post at the annulet.

6. The cylinder lockset with a focusing apparatus according to claim 1 to claim 3, wherein the hatch of key is thrust with number of real pins which are corresponded to the focusing holes of the rotary disc; Length of the real pins is longer than the thickness of the rotary disc and can reach to the real upper pins correspondingly.

7. The cylinder lockset with a focusing apparatus according to claim 6, wherein the real pins of key are designed in different length.

8. The cylinder lockset with a focusing apparatus according to claim 6, wherein the hatch of key is thrust with number of dummy pins which are corresponded to the bias holes of the rotary disc; Length of the real pins is shorter than the thickness of the rotary disc.

9. The cylinder lockset with a focusing apparatus according to claim 8, wherein the dummy pins of key are designed in different length.

10. The cylinder lockset with a focusing apparatus according to claim 6 to claim 9, wherein the flange of key is designed with a locking block, which is corresponded to and can be snapped in the slot and latch into the curved slot of chamber.

11. The cylinder lockset with a focusing apparatus according to claim 6 to claim 9, wherein the hatch of key is designed with a receiving hole, which is corresponded and received the guiding post of rotary disc.
